(19) United States
(12) Patent Application Publication
(10) Pub. No.: US 2025/0209757 A1
(43) Pub. Date: Jun. 26, 2025

(54) ELECTRONIC DEVICE

(71) Applicant: CANON KABUSHIKI KAISHA, Tokyo (JP)

(72) Inventor: SEIJI OGAWA, Tokyo (JP)

(21) Appl. No.: 19/074,632

(22) Filed: Mar. 10, 2025

Related U.S. Application Data
(63) Continuation of application No. PCT/JP2024/022636, filed on Jun. 19, 2023.

(30) Foreign Application Priority Data
Sep. 13, 2022 (JP) 2022-145046

(51) Int. Cl. G06T 19/00

(52) U.S. Cl. CPC G06T 19/006

(57) ABSTRACT

An electronic device according to the present invention includes one or more processors and/or circuitry configured to execute acquisition processing of acquiring information unique to a virtual space, and control processing of performing control to record the information unique to the virtual space when performing control to record an image of the virtual space.

### CROSS-REFERENCE TO RELATED APPLICATIONS

This application is a Continuation of International Patent Application No. PCT/JP2023/022636, filed Jun. 19, 2023, which claims the benefit of Japanese Patent Application No. 2022-145046, filed Sep. 13, 2022, all of which are hereby incorporated by reference herein in their entirety.

### BACKGROUND OF THE INVENTION

### Field of the Invention

The present invention relates to an electronic device, and more particularly to a technology of managing a plurality of images including an image of a virtual space (or an augmented reality space).

### Background Art

Virtual reality (VR) is a technology in which a computer generates (simulates) an environment in which a user can interact with a virtual object. In this technology, a virtual space that is a three-dimensional (3D) space similar to a real space is provided to a user. In the virtual space, a pseudo sense is given to the user by video, sound, and tactile feedback.

The user can view the virtual space by using a display device (for example, a head mounted display). The user can interact with a virtual object disposed in the virtual space by using a motion sensor or a controller.

In the virtual space, the user can communicate with another user by using a virtual character called an avatar as his/her virtual self. In addition, a camera function capable of capturing an image of a virtual space has been proposed. By using this camera function, the user can perform capturing in the virtual space in the same manner as capturing in the real space. For example, the user can capture an avatar of a friend or capture a scene in the virtual space, and can leave an image (image of the virtual space) obtained by capturing as a memory.

A technology called augmented reality (AR) is also known. In this technology, a virtual object is displayed so as to be superimposed on a real space (an image of the real space). A three-dimensional (3D) space provided to the user in the augmented reality is referred to as augmented reality space.

PTL 1 discloses a technology in which an image obtained by capturing a real space is displayed on a head-up display of a vehicle, and position information in the real space is added to the image when the image is stored. PTL 2 discloses an example of a camera function in a virtual space.

However, in the related art, it is not possible to suitably manage a plurality of images including an image (image of the virtual space) obtained by capturing in the virtual space. For example, it is assumed that the plurality of images include an image obtained by capturing in the virtual space (an image of the virtual space) and an image obtained by capturing in the real space (an image of the real space). In this case, if the reality of the image in the virtual space is high, it is not possible to easily identify the image in the virtual space and the image in the real space. Similarly, in the related art, it is not possible to suitably manage a plurality of images including an image of an augmented reality space.

The present invention provides an electronic device that is capable of suitably managing a plurality of images including an image in a virtual space (or an augmented reality space).

### CITATION LIST

### Patent Literature

PTL 1 US 2017/0076415 A

PTL 2 U.S. Pat. No. 10,948,993

### SUMMARY OF THE INVENTION

An electronic device according to the present invention includes one or more processors and/or circuitry configured to execute acquisition processing of acquiring information unique to a virtual space, and control processing of performing control to record the information unique to the virtual space when performing control to record an image of the virtual space.

Further features of the present invention will become apparent from the following description of exemplary embodiments with reference to the attached drawings.

### BRIEF DESCRIPTION OF THE DRAWINGS

FIGS. 1A and 1B are external views of an electronic device, FIG. 1C is a block diagram of the electronic device, and FIG. 1D is an external view of a VR goggle;

FIGS. 2A and 2B are external views of a controller;

FIG. 3 is a flowchart of OS mode processing;

FIG. 4 is a flowchart of virtual space application processing;

FIG. 5 is a flowchart of camera mode processing;

FIG. 6 is a flowchart of playback mode processing;

FIG. 7 is a schematic diagram illustrating an application selection screen;

FIGS. 8A to 8F are schematic diagrams of a virtual space application screen;

FIGS. 9A and 9B are schematic diagrams of a file display screen; and

FIGS. 10A to 10D are schematic diagrams of metadata in an Exif format.

### DESCRIPTION OF THE EMBODIMENTS

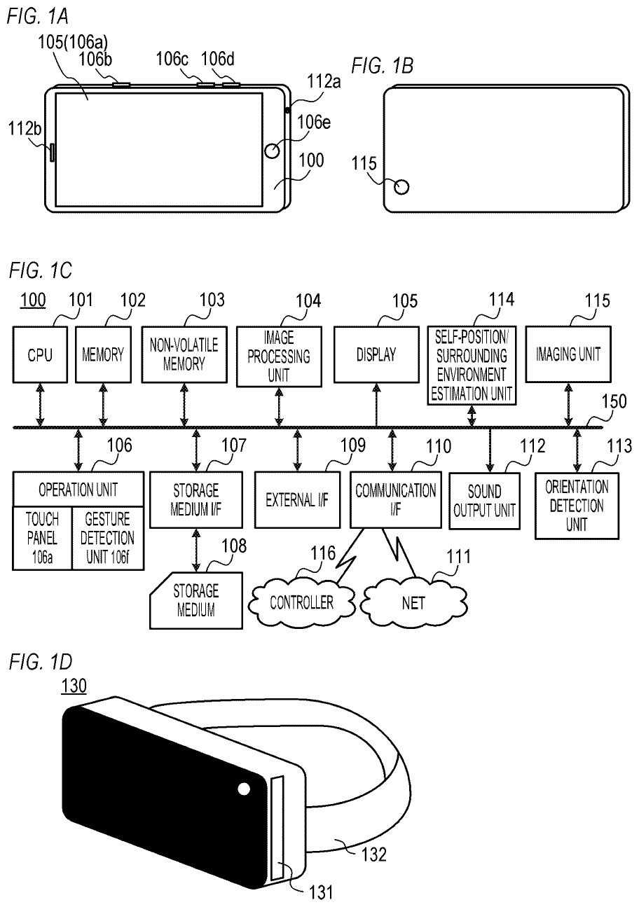

Hereinafter, embodiments of the present invention are described with reference to the drawings. FIG. 1A is a front perspective view of an electronic device 100. The electronic device 100 is a display device such as a smartphone or a tablet terminal. A display 105 is a display unit that displays an image and various types of information. The display 105 is configured integrally with a touch panel 106a, and can detect a touch operation on a display surface of the display 105. The electronic device 100 can perform VR display of a VR image (VR content) on the display 105. An operation member 106b is a power button that receives an operation to switch on and off power of the electronic device 100. An operation member 106c and an operation member 106d are volume buttons for increasing or decreasing the volume of the sound output from a speaker 112b, an earphone connected to a sound output terminal 112a, or an external speaker. An operation member 106e is a home button for displaying a home screen on the display 105. The sound output terminal 112a is an earphone jack, and is a terminal that outputs an audio signal to the earphone or the external speaker. The speaker 112b is a built-in speaker that outputs a sound.

FIG. 1B is a rear perspective view of the electronic device 100. An imaging unit 115 is a camera capable of imaging a real space.

FIG. 1C is a block diagram illustrating a configuration of the electronic device 100. A CPU 101, a memory 102, a non-volatile memory 103, an image processing unit 104, a display 105, an operation unit 106, a storage medium I/F 107, an external I/F 109, and a communication I/F 110 are connected to an internal bus 150. Furthermore, a sound output unit 112, an orientation detection unit 113, a self-position/surrounding environment estimation unit 114, and the imaging unit 115 are also connected to the internal bus 150. The units connected to the internal bus 150 can exchange data with each other via the internal bus 150.

The CPU 101 is a control unit that controls the entire electronic device 100, and includes at least one processor or circuit. The memory 102 is, for example, a RAM (volatile memory using a semiconductor element). For example, the CPU 101 controls each unit of the electronic device 100 using the memory 102 as a work memory according to a program stored in the non-volatile memory 103. The non-volatile memory 103 stores various information such as image data, audio data, other data, and various programs for operating the CPU 101. The non-volatile memory 103 is, for example, a flash memory or a ROM.

On the basis of the control of the CPU 101, the image processing unit 104 performs various types of image processing on an image stored in the non-volatile memory 103 or a storage medium 108, a video signal acquired via the external I/F 109, or an image acquired via the communication I/F 110. The various types of image processing include A/D conversion processing, D/A conversion processing, image data encoding processing, image data compression processing, image data decoding processing, image data enlargement/reduction processing (resizing), image data noise reduction processing, and image data color conversion processing. Furthermore, the various types of image processing also include panoramic development, mapping processing, and transformation of a VR image that is an omnidirectional image or a wide-range image having a wide range of video although not in all directions. The image processing unit 104 may be a dedicated circuit block for performing specific image processing. In addition, depending on the type of image processing, the CPU 101 can execute image processing according to a program without using the image processing unit 104.

The display 105 displays an image and a graphical user interface (GUI) screen constituting a GUI on the basis of the control of the CPU 101. The CPU 101 controls each unit of the electronic device 100 to generate a display control signal according to a program, generate a video signal to be displayed on the display 105, and output the video signal to the display 105. The display 105 displays a video on the basis of the generated and output video signal. Note that the configuration of the electronic device 100 itself may be at most an interface for outputting a video signal to be displayed on the display 105, and the display 105 may be an external monitor (for example, a television or a head mounted display).

The operation unit 106 includes various input units for receiving user operations. For example, the operation unit 106 includes a character information input device (for example, a keyboard), a pointing device (for example, a mouse or a touch panel), a button, a dial, a joystick, a touch sensor, and a touch pad. In the present embodiment, the operation unit 106 includes a touch panel 106a, the operation members 106b, 106c, 106d, and 106e, and a gesture detection unit 106f.

The storage medium 108 such as a memory card, a CD, or a DVD is attachable to and detachable from the storage medium I/F 107. The storage medium I/F 107 reads data from the attached storage medium 108 and writes data to the storage medium 108 under the control of the CPU 101. The storage medium 108 is a storage unit that stores various data including an image to be displayed on the display 105. The external I/F 109 is an interface for connecting to an external device in a wired or wireless manner and performing input/output (data communication) of a video signal and an audio signal. The communication I/F 110 is an interface for communicating (wirelessly communicating) with an external device or the Internet 111 to perform transmission and reception (data communication) of various data such as files and commands. The communication I/F 110 can also communicate (wirelessly communicate) with a controller 116.

The sound output unit 112 outputs sound of a moving image or music data reproduced by the electronic device 100, an operation sound, a ring tone, and various notification sounds. The sound output unit 112 includes the sound output terminal 112a to which an earphone or an external speaker is connected and a speaker 112b, but the sound output unit 112 may output audio data to the external speaker by wireless communication.

The orientation detection unit 113 detects the orientation (inclination) of the electronic device 100 with respect to the gravity direction or the orientation of the electronic device 100 with respect to each axis of the yaw direction, the pitch direction, and the roll direction, and notifies the CPU 101 of orientation information. On the basis of the orientation detected by the orientation detection unit 113, it is possible to determine whether the electronic device 100 is horizontally held, vertically held, directed upward, directed downward, or in an oblique attitude. In addition, it is possible to determine presence or absence and magnitude of inclination of the electronic device 100 in the rotation direction such as the yaw direction, the pitch direction, and the roll direction, and whether the electronic device 100 has rotated in the rotation direction. One of an acceleration sensor, a gyro sensor, a geomagnetic sensor, an orientation sensor, and an altitude sensor, or a combination of a plurality of sensors can be used as the orientation detection unit 113.

The self-position/surrounding environment estimation unit 114 estimates the self-position of the electronic device 100 or the VR goggles 130 described below and the surrounding environment.

The self-position is a position of the electronic device 100 or the VR goggles 130 in a space of a predetermined range. For example, the self-position is expressed by three parameters representing positions in a coordinate system defined by three axes of an X-axis, a Y-axis, and a Z-axis orthogonal to each other at a predetermined position in a space of a predetermined range so that the predetermined position becomes an origin. The self-position may be expressed by further using three parameters representing the orientation (direction).

The surrounding environment includes an obstacle area. The obstacle area is an area of an object that is an obstacle for the user carrying the electronic device 100 or the user wearing the VR goggles 130 among objects existing around the electronic device 100 or the VR goggles 130. For example, the obstacle area is expressed by a plurality of sets of three parameters representing positions in a coordinate system defined by three axes of an X-axis, a Y-axis, and a Z-axis orthogonal to each other at a predetermined position in a space of a predetermined range so that the predetermined position becomes an origin.

An imaging unit 115 is a camera capable of imaging a real space. The image obtained by imaging the real space can be used for various detection processing, and is used by, for example, the gesture detection unit 106f and the self-position/surrounding environment estimation unit 114. Furthermore, an image obtained by imaging the real space can be displayed on the display 105.

As described above, the operation unit 106 includes the touch panel 106a. The touch panel 106a is an input device configured to overlap the display 105 in a planar manner and output coordinate information corresponding to a position being touched. For the touch panel 106a, the CPU 101 can detect the following operations or states.
An operation body (for example, a finger or a pen) that is not in contact with the touch panel 106a newly touches the touch panel 106a, that is, a start of a touch (hereinafter referred to as touch-down).
A state in which the operation body is in contact with the touch panel 106a (hereinafter referred to as touch-on).
An operation body moving in contact with the touch panel 106a (hereinafter referred to as touch-move)
An operation in which an operation body that is in contact with the touch panel 106a is separated from the touch panel 106a, that is, an end of the touch (hereinafter referred to as touch-up).
A state in which nothing is in contact with the touch panel 106a (hereinafter referred to as touch-off).

When the touch-down is detected, the touch-on is detected at the same time. After the touch-down, the touch-on is continuously detected unless the touch-up is detected. Also, when the touch-move is detected, the touch-on is detected at the same time. Even if the touch-on is detected, the touch-move is undetected as long as the touch position is not moved. After the touch-up of all the operation bodies having been in contact with the touch panel is detected, the touch-off is established.

These operations and states and the position coordinates of the operation body that is in contact with the touch panel 106a are notified to the CPU 101 through an internal bus. The CPU 101 determines what kind of operation (touch operation) is executed on the touch panel 106a, based on the notified information. With regard to the touch-move, a movement direction of the operation body moving on the touch panel 106a can be determined for each vertical component and for each horizontal component on the touch panel 106a, based on a change of the position coordinates. When the touch-move for a predetermined distance or more is detected, it is determined that a sliding operation has been performed.

An operation in which an operation body is swiftly moved by a certain distance while being in contact with the touch panel 106a and is separated is called a flick. In other words, the flick is an operation in which the operation body is swiftly slid on the touch panel 106a so as to flick the touch panel 106a. When the touch-move at a predetermined speed or higher for a predetermined distance or more is detected and then the touch-up is detected, it can be determined that a flick has been performed (it can be determined that a flick has been performed following the sliding operation).

Further, a touch operation in which a plurality of locations (for example, two locations) is touched at the same time and touch positions are brought close to each other is referred to as a pinch-in, and a touch operation in which the touch positions are moved away from each other is referred to as a pinch-out. The pinch-out and the pinch-in are collectively referred to as a pinch operation (or simply referred to as a pinch). A method of the touch panel 106a may be any of various methods including resistive, capacitive, surface acoustic wave, infrared light, electromagnetic induction, image recognition, and optical sensor methods. There are a method of detecting a touch based on contact with a touch panel, and a method of detecting a touch based on approach of an operation body to the touch panel, but any method may be adopted.

As described above, the operation unit 106 includes the gesture detection unit 106f. The gesture detection unit 106f detects the gesture of the user (for example, the hand of the user) from the image obtained by the imaging unit 115 (the image obtained by imaging the real space) on the basis of the control of the CPU 101. The CPU 101 performs various types of processing (control) according to the detected gesture.

FIG. 1D is an external view of the VR goggle (head mounted adapter) 130 to which the electronic device 100 can be attached. The electronic device 100 can also be used as a head-mounted display by being attached to the VR goggles 130. An insertion port 131 is an insertion port into which electronic device 100 is inserted. The entire electronic device 100 can be inserted into the VR goggles 130 with the display surface of the display 105 facing a headband 132 side (that is, the user side) for fixing the VR goggles 130 to the user's head. The user can visually recognize the display 105 without holding the electronic device 100 with his/her hand while wearing the VR goggles 130 to which the electronic device 100 is attached on the head. In this case, when the user moves the head or the entire body, the orientation of the electronic device 100 also changes. The orientation detection unit 113 detects a change in the orientation of the electronic device 100 at this time, and the CPU 101 performs processing for VR display (display in the display mode “VR view”) on the basis of the change in the orientation. In this case, detecting the orientation of the electronic device 100 by the orientation detection unit 113 is equivalent to detecting the orientation of the head of the user (the direction in which the line of sight of the user is directed). The VR display (VR view) is a display method (display mode) for displaying, from among VR images, a video in a field-of-view range depending on the orientation of the display device, the display method being capable of changing its display range.

Note that the electronic device 100 itself may be a head mounted display that can be attached on the head even without VR goggles. The electronic device 100 may be capable of detecting a gaze or facial expression of the user, and the user may be able to operate the electronic device 100 with the gaze or facial expression.

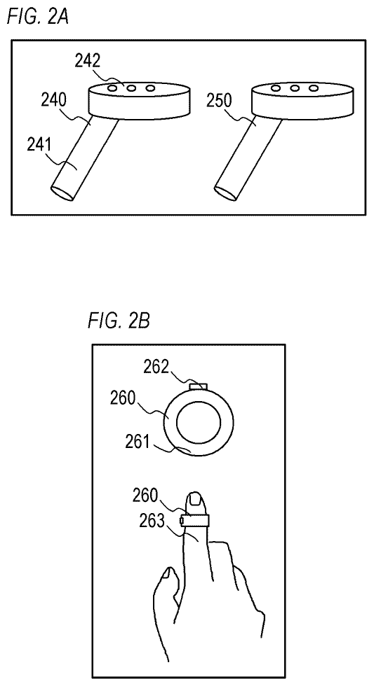

FIG. 2A is an external view of the controller 116 that is an example of controllers 240 and 250 that can communicate with the electronic device 100. The controller 240 is a grip type controller operated by the user with the left hand. The user grips a hold portion 241 of the controller 240 with the left hand, and operates operation members arranged on an operation surface 242 with a finger (for example, a thumb) of the left hand. The controller 240 notifies the electronic device 100 of an operation performed by the user. The controller 250 is a grip type controller operated by the user with the right hand, and has the same configuration as the controller 240 (for example, a form in which the controller 240 is horizontally inverted).

As the controller 116, a controller 260 illustrated in FIG. 2B may be used. The controller 260 is a ring-shaped controller that is operated by being worn on a finger of a user. The controller 260 includes a ring portion 261 to be worn on a user's finger 263 and an operation member 262. The operation member 262 is, for example, a push button, a rotary dial, or an optical track pad. The optical track pad is a type of operation member capable of detecting contact or approach of a finger.

In the following description, it is assumed that the user wears the VR goggles 130 on which the electronic device 100 is attached.

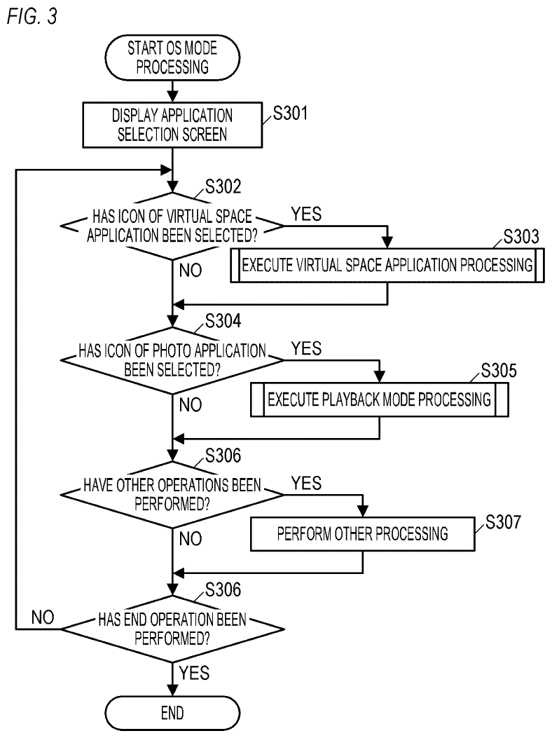

FIG. 3 is a flowchart for illustrating OS mode processing of the electronic device 100. This process is implemented by the CPU 101 loading a program stored in the non-volatile memory 103 to the memory 102 and executing the loaded program. When detecting that the electronic device 100 is worn on the VR goggles 130 or when detecting that a predetermined operation is performed, the CPU 101 executes the OS mode processing of FIG. 3.

In step S301, the CPU 101 displays an application selection screen on the display 105.

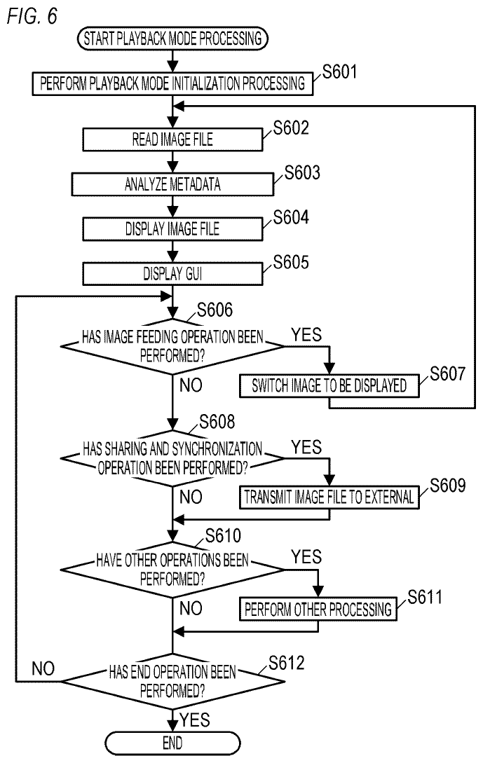

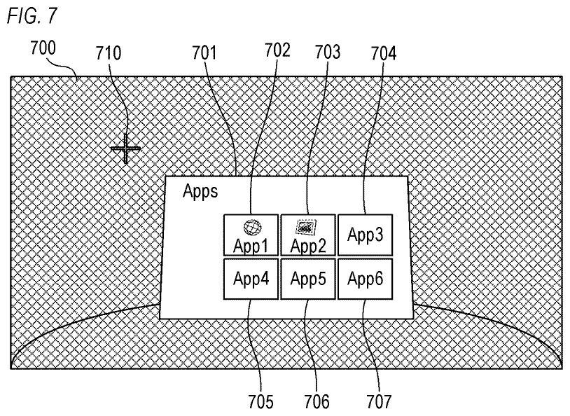

FIG. 7 illustrates an application selection screen 701. The application selection screen 701 is displayed to be superimposed on a virtual space 700. A plurality of icons (icons 702 to 707) corresponding to a plurality of applications installed in the electronic device 100 are displayed on the application selection screen 701. When an operation of selecting an icon is performed, the CPU 101 starts an application corresponding to the selected icon. For example, when the icon 702 is selected, a virtual space application that provides a predetermined virtual space to the user is activated, and when the icon 703 is selected, a photo application that reproduces an image stored in the electronic device 100 is activated. Note that a plurality of virtual space applications may be installed in the electronic device 100.

Even in a state where the user wears the VR goggles 130 to which the electronic device 100 is attached, the user can select and move the GUI displayed on the display 105 using the controller 116. For example, the user can move a pointer 710 in FIG. 7 to an optional position by the orientation of the user, the direction of the line of sight, or an operation on the controller. Then, the user can select an icon by bringing the pointer 710 close to (or superimposing) an optional icon and operating an operation member of the controller.

In step S302, the CPU 101 determines whether the icon 702 of the virtual space application has been selected. If the CPU 101 determines that the icon 702 is selected, the process proceeds to step S303, and if not, the process proceeds to step S304.

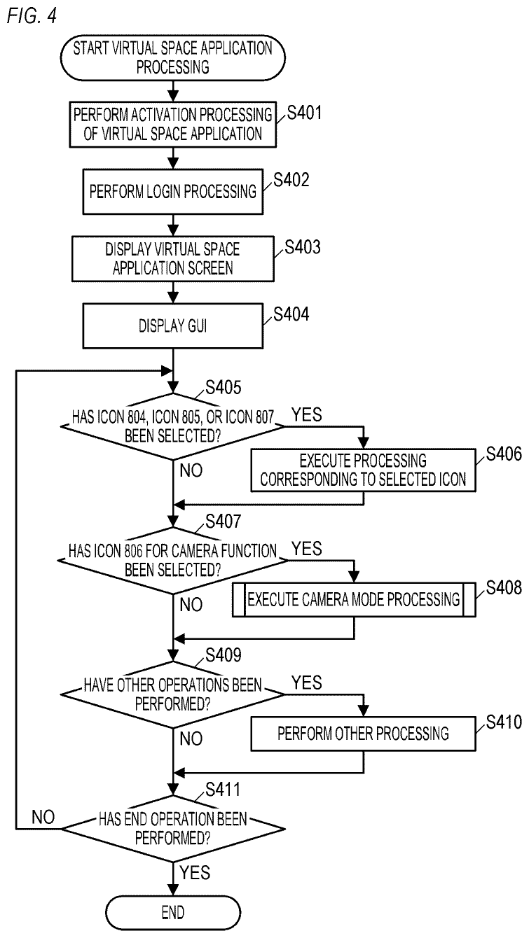

In step S303, the CPU 101 executes virtual space application processing. Details of the virtual space application processing will be described later with reference to FIG. 4.

In step S304, the CPU 101 determines whether the icon 703 of the photo application has been selected. If the CPU 101 determines that the icon 703 is selected, the process proceeds to step S305, and if not, the process proceeds to step S306.

In step S305, the CPU 101 executes playback mode processing (photo application processing). In the playback mode processing in step S305, all the images stored in the storage medium 108 are set as candidates for a playback target (image to be reproduced). Details of the playback mode processing will be described later with reference to FIG. 6.

In step S306, the CPU 101 determines whether or not other operations have been performed. Other operations include, for example, an operation of pairing the electronic device 100 with an external device (for example, a smartphone different from the electronic device 100), and an operation of enabling or disabling a function of automatically transmitting an image (captured image) obtained by capturing to the paired external device. If the CPU 101 determines that other operations have been performed, the process proceeds to step S307, and if not, the process proceeds to step S308.

In step S307, the CPU 101 performs other processing (processing corresponding to the operations detected in step S306).

In step S308, the CPU 101 determines whether or not an operation to end the OS mode processing has been performed. If it is determined that the end operation has been performed, the CPU 101 ends the OS mode processing of FIG. 3, and if not, the process proceeds to step S302.

FIG. 4 is a flowchart illustrating virtual space application processing (step S303 in FIG. 3) of the electronic device 100. This process is implemented by the CPU 101 loading a program stored in the non-volatile memory 103 to the memory 102 and executing the loaded program.

In step S401, the CPU 101 performs activation processing of the virtual space application. For example, the CPU 101 develops the program of the virtual space application stored in the non-volatile memory 103 in the memory 102 and executes the program. Then, the CPU 101 initializes a control variable (for example, a flag) used in the virtual space application.

In step S402, the CPU 101 performs login processing to the server that provides the service of the virtual space application on the basis of the account information of the user. Then, the CPU 101 loads the user information (for example, avatar information and attribute information) from the server. The avatar is a virtual character used by the user as his/her virtual self.

In step S403, the CPU 101 displays the virtual space application screen on the display 105.

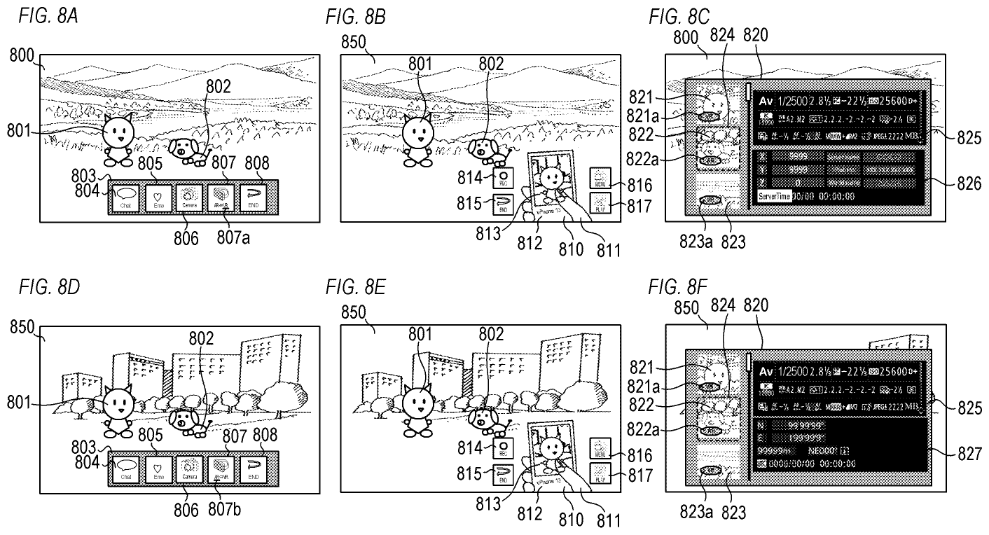

FIG. 8A illustrates the virtual space application screen. A virtual space 800, a virtual person 801, and a virtual animal 802 are displayed on the virtual space application screen of FIG. 8A. The virtual person 801 and the virtual animal 802 may be avatars of other users (virtual characters whose behavior is controlled in accordance with instructions from other users), or may be virtual characters whose behavior is automatically controlled. The virtual space application screen in FIG. 8A is a first-person viewpoint screen in which the avatar of the user viewing the virtual space application screen is not displayed. The virtual space application screen may be a third-person viewpoint screen on which an avatar of the user viewing the virtual space application screen is displayed.

In step S404, the CPU 101 displays a GUI for performing various operations on the virtual space application screen.

For example, the CPU 101 displays the GUI 803 of FIG. 8A so as to be superimposed on the virtual space 800. The GUI 803 includes a plurality of icons (icons 804 to 808) corresponding to a plurality of functions. The icon 804 corresponds to the chat function, and the icon 805 corresponds to the motion function. Both the chat function and the emotion function are functions for communicating with other users. The icon 806 corresponds to a camera function for performing capturing by a camera (virtual camera) in the virtual space. The icon 807 is a switching button for switching the space to be displayed between the virtual space (virtual reality (VR) space) and the augmented reality (AR) space. The icon 807 is displayed so that the current space enables identification. Since the virtual space 800 is displayed in FIG. 8A, an item 807a indicating that the displayed space is the virtual space (virtual space display is being performed) is displayed. Then, the icon 808 is an end button for ending the virtual space application.

When the icon 807 in FIG. 8A is selected (operated) by the user, the CPU 101 causes the virtual space application screen to be displayed to transition from the screen in FIG. 8A to the screen in FIG. 8D. In FIG. 8D, not virtual space 800 but the augmented reality space 850 is displayed as a background on which the virtual person 801, the virtual animal 802, and the GUI 803 are superimposed. Therefore, in the icon 807, an item 807b indicating that the displayed space is the augmented reality space (that the augmented reality space display is performed) is displayed.

In step S405, the CPU 101 determines whether the icon 804, the icon 805, or the icon 807 has been selected. If the CPU 101 determines that the icon 804, the icon 805, or the icon 807 has been selected, the process proceeds to step S406, and if not, the process proceeds to step S407.

In step S406, the CPU 101 executes processing corresponding to the selected icon (icon 804, icon 805, or icon 807). For example, the CPU 101 performs processing for communicating with another user, or performs processing for switching a space to be displayed between the virtual space and the augmented reality space.

In step S407, the CPU 101 determines whether the icon 806 for the camera function has been selected. If the CPU 101 determines that the icon 806 has been selected, the process proceeds to step S408, and if not, the process proceeds to step S409.

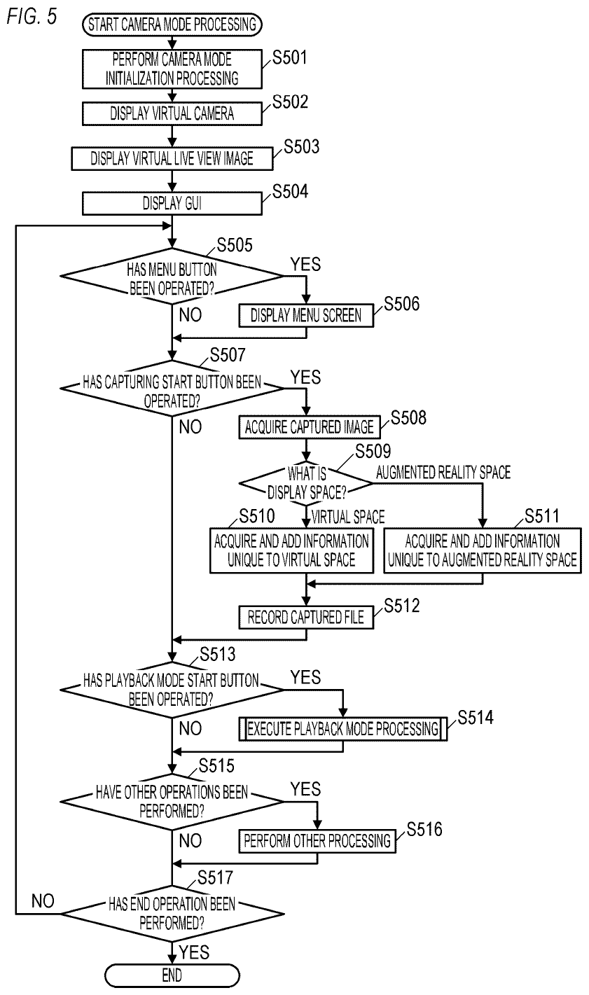

In step S408, the CPU 101 executes camera mode processing. Details of the camera mode processing will be described later with reference to FIG. 5.

In step S409, the CPU 101 determines whether or not other operations have been performed. If the CPU 101 determines that other operations have been performed, the process proceeds to step S410, and if not, the process proceeds to step S411.

In step S410, the CPU 101 performs other processing (processing corresponding to the operations detected in step S409). For example, it is assumed that the user wearing the VR goggles 130 moves in the real space. Then, the CPU 101 changes the display range of the space displayed on the display 105 (the virtual space 800 or the augmented reality space 850) such that the position of the user in the virtual space changes according to the movement of the user in the real space.

In step S411, the CPU 101 determines whether or not an end operation (selection of the icon 808) of the virtual space application processing has been performed. If it is determined that the end operation has been performed, the CPU 101 ends the virtual application processing of FIG. 4, and if not, the process proceeds to step S405.

FIG. 5 is a flowchart illustrating camera mode processing (step S408 in FIG. 4) of the electronic device 100. This process is implemented by the CPU 101 loading a program stored in the non-volatile memory 103 to the memory 102 and executing the loaded program.

In step S501, the CPU 101 performs camera mode initialization processing. For example, the CPU 101 reads various parameters set when the user used the camera mode last time.

In step S502, the CPU 101 displays the virtual camera on the virtual space application screen.

In step S503, the CPU 101 displays a virtual live view image on the display of the virtual camera.

In step S504, the CPU 101 displays the GUI for operating the camera mode on the virtual space application screen.

FIG. 8B illustrates the virtual space application screen in the camera mode. In the virtual space application screen of FIG. 8B, the virtual space display is performed. In FIG. 8B, a virtual camera 810 is displayed as being held by a virtual hand 811. A virtual camera name 812 and a virtual live view image 813 are superimposed and displayed on the virtual camera 810. Then, a plurality of GUIs corresponding to a plurality of functions of the camera mode are displayed around the virtual camera 810. In FIG. 8B, a capturing start button 814, a camera mode end button 815, a menu button 816, and a playback mode start button 817 are displayed as a plurality of GUIs.

FIG. 8E illustrates the virtual space application screen in the camera mode. In the virtual space application screen in FIG. 8E, the augmented reality space display is performed. Also in FIG. 8E, the virtual camera 810 and the virtual hand 811 are displayed as in FIG. 8B. Similarly to FIG. 8B, the virtual camera name 812, the virtual live view image 813, the capturing start button 814, the camera mode end button 815, the menu button 816, and the playback mode start button 817 are also displayed.

In step S505, the CPU 101 determines whether the menu button 816 has been operated. If the CPU 101 determines that the menu button 816 has been operated, the process proceeds to step S506, and if not, the process proceeds to step S507.

In step S506, the CPU 101 displays the menu screen on the display 105. The user can perform various settings related to the camera mode (virtual camera) using the menu screen. For example, the user can use the menu screen to set the format of the captured image, the capturing parameter, and the format of the metadata to be added (associated) to the captured image. At least one of a still image, a moving image, a two-dimensional image, a three-dimensional image, a 360° image, and a VR180 image (VR180 standard image) is set as the format of the captured image. At least one of a shutter speed, a diaphragm, ISO sensitivity, an exposure correction step value, white balance, and a focus mode is set as the capturing parameter. Image processing such as background blurring and a skin beautifying effect may be set as the capturing parameter. The format of the metadata added to the captured image will be described later.

In step S507, the CPU 101 determines whether the capturing start button 814 has been operated. If the CPU 101 determines that the capturing start button 814 has been operated, the process proceeds to step S508, and if not, the process proceeds to step S513.

In step S508, the CPU 101 acquires the captured image (image to be recorded) of the virtual camera. For example, in a case of obtaining a two-dimensional image as a captured image, the CPU 101 obtains a captured image corresponding to the current virtual live view image. In a case where a 360° image is obtained as the captured image, the CPU 101 acquires a captured image representing the appearance of 360° from the position of the virtual camera.

In step S509, the CPU 101 determines whether the current display is the virtual space display or the augmented reality space display. If the CPU 101 determines that the display is the virtual space display, the process proceeds to step S510, and if not (if it is determined that the display is the augmented reality space display), the process proceeds to step S511.

In step S510, the CPU 101 acquires information unique to the virtual space, and adds metadata including the information to the captured image acquired in step S508.

In step S511, the CPU 101 acquires information unique to the augmented reality space, and adds metadata including the information to the captured image acquired in step S508.

Note that the metadata may be generated such that at least one of the image of the virtual space and the image of the augmented reality space enables identification, and the format of the metadata is not particularly limited. In order to make the image of the virtual space identifiable, information unique to the virtual space may be included in the metadata in step S510. In that case, even if the information unique to the augmented reality space is not acquired in step S511, the image of the virtual space and the image of the non-virtual space are identifiable. The non-virtual space is a space different from the virtual space, and is, for example, a real space or an augmented reality space. Similarly, in order to make the image of the augmented reality space identifiable, information unique to the augmented reality space may be included in the metadata in step S511. In that case, even if the information unique to the virtual space is not acquired in step S510, the image of the augmented reality space and the image of the non-augmented reality space are identifiable. The non-augmented reality space is a space different from the augmented reality space, for example, a real space or a virtual space.

The information unique to the virtual space includes, for example, a flag indicating the virtual space, position information in the virtual space, and time information in the virtual space. The information unique to the augmented reality space includes, for example, a flag indicating that the space is an augmented reality space. Although information unique to the augmented reality space may be used as the position information in the augmented reality space, the position information in the augmented reality space is generally the same as the position information in the real space. Similarly, information unique to the augmented reality space may be used as time information in the augmented reality space, but time information in the augmented reality space is generally the same as time information in the real space.

The metadata may or may not be information (data) in an exchangeable image file format (Exif). In the case of the Exif format, various parameters such as a shutter speed at the time of capturing, an aperture, an ISO sensitivity, and an exposure correction step value can be included in the metadata. In a case where a moving image is obtained as a captured image, one piece of metadata may be added to the entire moving image, metadata may be added for each frame of the moving image, or metadata may be added for each scene of the moving image.

In step S512, the CPU 101 records (saves) the file (image file) of the captured image to which the metadata is added in the storage medium 108. The file of the captured image (captured image of the virtual camera) acquired in step S508 may be recorded in the same area as the file of another image (for example, the image of the real space obtained by the imaging unit 115), or may be recorded in a different area. The captured image acquired in step S508 may be recorded in an area unique to the virtual space application. The captured image acquired in step S508 may be directly stored in an external device or a server.

In step S513, the CPU 101 determines whether or not the playback mode start button 817 has been operated. If the CPU 101 determines that the playback mode start button 817 has been operated, the process proceeds to step S514, and if not, the process proceeds to step S515.

In step S514, the CPU 101 executes playback mode processing. The playback mode processing in step S514 is different from the playback mode processing in step S305. For example, the playback mode processing in step S514 is processing unique to the virtual space application, and the playback mode processing in step S305 is processing of the photo application included in the OS. In the playback mode processing of step S514, among the images stored in the storage medium 108, an image recorded by the virtual space application (captured image of the virtual camera) is set as a candidate for a playback target (image to be played back). Details of the playback mode processing will be described later with reference to FIG. 6.

In step S515, the CPU 101 determines whether or not other operations have been performed. If the CPU 101 determines that other operations have been performed, the process proceeds to step S516, and if not, the process proceeds to step S517.

In step S516, the CPU 101 performs other processing (processing corresponding to the operations detected in step S515). For example, the CPU 101 changes the angle of view (subject range) of the virtual live view image according to an orientation change of the VR goggles 130 or an operation on the controller 116.

In step S517, the CPU 101 determines whether or not an end operation of the camera mode processing (operation of the camera mode end button 815) has been performed. If it is determined that the end operation has been performed, the CPU 101 ends the camera mode processing of FIG. 5, and if not, the process proceeds to step S505.

FIG. 6 is a flowchart illustrating playback mode processing (step S305 in FIG. 3 or step S514 in FIG. 5) of the electronic device 100. This process is implemented by the CPU 101 loading a program stored in the non-volatile memory 103 to the memory 102 and executing the loaded program.

In step S601, the CPU 101 performs playback mode initialization processing. For example, the CPU 101 reads an index number of an image that the user has browsed when using the playback mode last time and various parameters related to browsing.

In step S602, the CPU 101 reads the image file stored (saved) in the storage medium 108. In the case of the playback mode processing in step S305 in FIG. 3, all image files stored in the storage medium 108 are read. In the case of the playback mode processing of step S514 of FIG. 5, the image file recorded by the virtual space application is read out of the image files stored in the storage medium 108.

In step S603, the CPU 101 analyzes the metadata of the image file read in step S602.

In step S604, the CPU 101 displays the image file read in step S602 on the display 105. An image (video) of one image file may be displayed on the playback screen, or a list of a plurality of image files may be displayed on the file display screen. On the file display screen, a thumbnail obtained by compressing an image of the image file may be displayed as an icon indicating the image file.

In step S605, the CPU 101 determines whether the image (image file) read in step S602 is an image of the virtual space or an image of the non-virtual space, and displays a GUI that enables identification of the image of the virtual space and the image of the non-virtual space on the display 105.

FIG. 8C illustrates a screen in the playback mode. On the screen of FIG. 8C, a GUI 820 (file display screen) in the playback mode is displayed. A list of thumbnails 821 to 823 of the read images (image files) is displayed on the GUI 820. The items 821a and 823a indicating an image of the virtual space are superimposed and displayed on the thumbnails 821 and 823 of the image of the virtual space on the basis of the analysis result of the metadata of each image. Then, the item 822a indicating that the image is of the non-virtual space is superimposed and displayed on the thumbnail 822 of the image of the non-virtual space. The screen of FIG. 8C is the virtual space application screen in the playback mode, that is, the screen displayed in the playback mode processing of step S514 of FIG. 5. Therefore, an item (item describing “AR”) indicating an image of the augmented reality space is displayed as the item 822a indicating an image of the non-virtual space. However, in the case of the playback mode processing of step S305 of FIG. 3, the thumbnail of the image of the real space may be displayed. Therefore, not the item in which “AR” is described but the item in which “Non-VR” is described, for example, may be displayed as the item indicating the image of the non-virtual space. The item indicating the image of the non-virtual space may not be displayed. Furthermore, since the virtual space display is performed on the virtual application screen of FIG. 8C, the GUI 820 is displayed superimposed on the virtual space 800.

A cursor 824 is superimposed and displayed on the thumbnail 821. Further, detailed information (information display screen) of the image (image of the virtual space) corresponding to the thumbnail 821 on which the cursor 824 is superimposed is displayed on the right side of the thumbnails 821 to 823. Setting information 825 and capturing information 826 are displayed as detailed information. The setting information 825 includes information regarding the setting of the camera at the time of capturing, and the capturing information 826 includes other information at the time of capturing. Since the image of the thumbnail 821 is an image of the virtual space, information regarding the setting (for example, the format of the captured image and the capturing parameter) of the virtual camera at the time of capturing is displayed as the setting information 825. Then, the capturing information 826 includes position information of the virtual camera (person who captures image) in the virtual space at the time of capturing. This position information expresses a position of virtual camera (person who captures image) in the virtual space by three parameters representing positions in a coordinate system defined by three axes of an X-axis, a Y-axis, and a Z-axis orthogonal to each other at a predetermined position in a space of a predetermined range so that the predetermined position in the virtual space becomes an origin. Furthermore, the capturing information 826 includes a server name where the person who captures an image has logged in, a publishing IP address of the server, a virtual space name (world name), and time information in the server (in the virtual space). The time information in the server may be substantially the same as the time information in the electronic device 100 (in the real space).

Note that the example in which the file of the image of the virtual space is identifiably displayed on the file display screen by the display of the information (for example, the item 822a and the capturing information 826) based on at least a part of the information unique to the virtual space has been described, but the present invention is not limited thereto. For example, control may be performed to display information based on at least a part of information unique to the virtual space on a playback screen of the image of the virtual space.

FIG. 8F illustrates a screen (virtual application screen) in the playback mode. Since the augmented reality space display is performed on the virtual application screen of FIG. 8F, the GUI 820 (file display screen) is displayed superimposed on the augmented reality space 850. In FIG. 8F, the cursor 824 is displayed while superimposed on the thumbnail 822. Therefore, detailed information (information display screen) of the image (the image of the augmented reality space) corresponding to the thumbnail 822 is displayed on the right side of the thumbnails 821 to 823. The setting information 825 and the capturing information 827 are displayed as detailed information. In the present embodiment, the CPU 101 records the position information and the time information in the virtual space when recording the image of the virtual space, and records the position information and the time information in the real space when recording the image of the non-virtual space. Therefore, the capturing information 827 includes position information of the virtual camera (person who captures image) in the real space at the time of capturing. This position information expresses the position of the virtual camera (person who captures image) in the real space by latitude, longitude, and altitude. The position information in the real space may be position information of the electronic device 100 or the VR goggles 130. In addition, the capturing information 827 includes a direction indicating a capturing direction and time information in the electronic device 100 (in real space).

In step S606, the CPU 101 determines whether or not an image feeding operation has been performed. If the CPU 101 determines that the image feeding operation has been performed, the process proceeds to step S607, and if not, the process proceeds to step S608.

In step S607, the CPU 101 switches the image (one or more images) displayed on the display 105 to the image (one or more images) with the next index (image feed).

In step S608, the CPU 101 determines whether or not an image sharing and synchronization operation has been performed. If the CPU 101 determines that the image sharing and synchronization operation has been performed, the process proceeds to step S609, and if not, the process proceeds to step S610.

In step S609, the CPU 101 transmits the image file to the external device or the server. The external device is, for example, a smartphone paired with electronic device 100. The external device may be a storage device (for example, an HDD) having a communication function. The server is, for example, a server of a social networking service (SNS). The server may be an online storage on the cloud.

In step S610, the CPU 101 determines whether or not other operations have been performed. If the CPU 101 determines that other operations have been performed, the process proceeds to step S611, and if not, the process proceeds to step S612.

In step S611, the CPU 101 performs other processing (processing corresponding to the operations detected in step S610). For example, the CPU 101 performs editing processing such as color tone change and trimming on the image.

In step S612, the CPU 101 determines whether or not an operation to end the playback mode processing has been performed. If it is determined that the end operation has been performed, the CPU 101 ends capturing mode processing of FIG. 6, and if not, the process proceeds to step S606.

Note that, although the example of performing display in which the image of the virtual space and the image of the non-virtual space enable identification has been described, display in which the image of the augmented reality space and the image of the non-augmented reality space enable identification may be performed. Three types of images of the image of the virtual space, the image of the augmented reality space, and the image of the real space may be displayed in an identifiable manner.

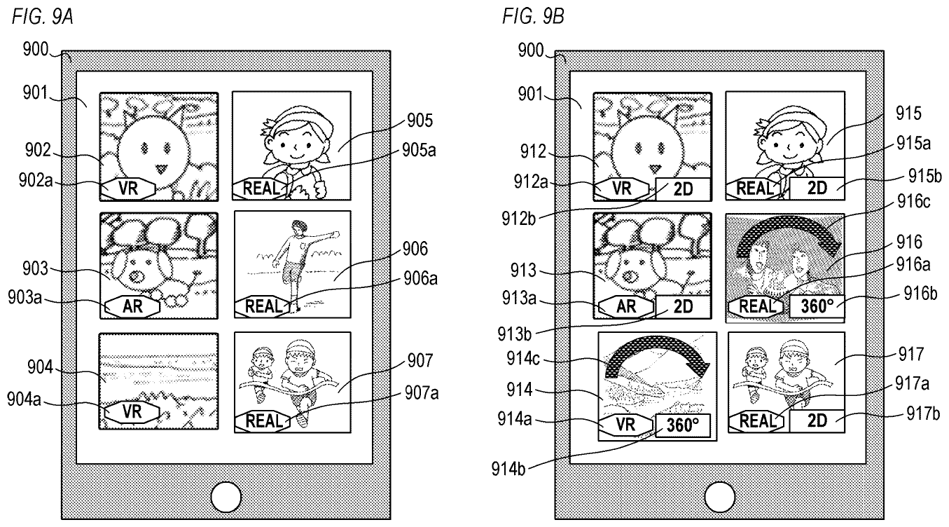

FIG. 9A illustrates a file display screen. In FIG. 9A, an image (image file) is transmitted from the electronic device 100 to a smartphone 900 paired with the electronic device 100, and a file display screen is displayed on the display 901 of the smartphone 900. On the file display screen of FIG. 9A, a plurality of thumbnails (thumbnails 902 to 907) respectively corresponding to a plurality of images including an image transmitted from the electronic device 100 are listed. Items 902a and 904a indicating an image of the virtual space are superimposed and displayed on the thumbnails 902 and 904 of the image of the virtual space. Item 903a indicating an image of the augmented reality space is superimposed and displayed on the thumbnail 903 of the image of the augmented reality space. Items 905a and 907a indicating an image of the real space are superimposed and displayed on the thumbnails 905 and 907 of the image of the real space. According to such display, three types of images of the image of the virtual space, the image of the augmented reality space, and the image of the real space enable identification.

In addition, display may be performed such that the angle of view of the image enables identification. For example, display may be performed such that an image with a normal angle of view and a 360° image enable identification. The display may be performed such that the two-dimensional image and the three-dimensional image enable identification.

FIG. 9B illustrates a file display screen. In FIG. 9B, an image (image file) is transmitted from the electronic device 100 to a smartphone 900 paired with the electronic device 100, and a file display screen is displayed on the display 901 of the smartphone 900. Similarly to the file display screen of FIG. 9A, the file display screen of FIG. 9B displays a list of a plurality of thumbnails (thumbnails 912 to 917) respectively corresponding to a plurality of images including an image transmitted from the electronic device 100 are listed. Items 912a and 914a indicating an image of the virtual space are superimposed and displayed on the thumbnails 912 and 914 of the image of the virtual space. Item 913a indicating an image of the augmented reality space is superimposed and displayed on the thumbnail 913 of the image of the augmented reality space. Items 905a and 907a indicating an image of the real space are superimposed and displayed on the thumbnails 915 and 917 of the image of the real space. According to such display, three types of images of the image of the virtual space, the image of the augmented reality space, and the image of the real space enable identification.

Furthermore, items 912b, 913b, 915b, and 917b indicating a two-dimensional image are displayed to be superimposed on the thumbnails 912, 913, 915, and 917 of the two-dimensional image with the normal angle of view. Items 914b and 916b indicating a 360° image are superimposed and displayed on the thumbnails 914 and 916 of the three-dimensional image at 360°. Furthermore, rotation displays 914c and 916c of the thumbnails 914 and 916 of the 360° image is performed. According to such display, the image of the normal angle of view and the 360° image enable identification. The two-dimensional image and the three-dimensional image enable identification.

Note that an item indicating a normal angle of view may be displayed, or an item indicating a three-dimensional image may be displayed. The display may be performed such that the VR180 image enables identification. For example, an item indicating the VR180 image may be superimposed and displayed on the thumbnail of the VR180 image. Rotation display of the thumbnail of the VR180 image may be performed.

Note that the example in which the position information in the virtual space is added to the image of the virtual space and the position information in the real space is added to the image of the non-virtual space has been described, but the present invention is not limited thereto. For example, the user (person who captures image) may be able to set in advance which of the position information in the real space and the position information in the virtual space is recorded (added). The administrator of the server or the administrator of the virtual space may be able to collectively perform such setting for a plurality of users. For example, the position information in the real space may be added to an image of the virtual space imitating the real space, and the position information in the virtual space may be added to an image of the real space imitating the virtual space. The position information in the virtual space may also be added to the image of the real space (for example, an image of a real space used to arrange a room of a real apartment as a room of a virtual apartment) used to construct the virtual space. Both the position information in the virtual space and the position information in the real space may be added to the image. In this case, both the position information in the virtual space and the position information in the real space may be displayed on the information display screen (for example, the capturing information 826 in FIG. 8C or the capturing information 827 in FIG. 8F).

Not only the position information in the virtual space but also whether or not to record information unique to the virtual space may be set. For example, the CPU 101 sets whether or not to record information unique to the virtual space in accordance with an instruction from a person who captures images (user), an administrator of the server, or an administrator of the virtual space.

Note that the position information in the virtual space may indicate the position of the virtual camera in the virtual space or the position of the person who captures images (avatar) in the virtual space. The person who captures images (user), the administrator of the server, or the administrator of the virtual space may be able to set which of the position information of the virtual camera and the position information of the person who captures images is added to the image. Furthermore, in a case where the space of the image is different from the space of the position information, information indicating that the space of the image is different from the space of the position information may be further added to the image. The case where the space of the image is different from the space of the position information is, for example, a case where the position information in the real space is added to the image of the virtual space, or a case where the position information in the virtual space is added to the image of the real space.

Note that the virtual camera may be installed at a position away from the position of the person who captures images (avatar). Then, in a case where the virtual camera is installed at a position away from the person who captures images, setting for adding the position information of the virtual camera to the image may be automatically performed. For example, usually, the position information of the person who captures images is added to the image without adding the position information of the virtual camera. Then, when the virtual camera is installed at a position away from the person who captures images, the position information of the virtual camera is added to the image without adding the position information of the person who captures images. When the virtual camera is installed at a position distant from the person who captures images, both the position information of the person who captures images and the position information of the virtual camera may be added to the image. Furthermore, in a case where a VR format such as a 360° image or a VR180 image is set as the format of the captured image, setting for adding the position information of the virtual camera to the image may be automatically performed.

Note that the format of the position information in the virtual space is not particularly limited. The position information in the virtual space may include information of a polar coordinate system. For example, the position information in the virtual space may include an origin of the virtual space (three-dimensional space), a distance from the origin, a direction, an elevation angle, and an altitude. In a case where capturing is performed on the virtual earth, the position information in the virtual space may include latitude and longitude on the virtual earth. The position information in the virtual space may be information indicating an area in the virtual space. The position information in the virtual space may be information indicating a distance from a predetermined position. The position information in the virtual space may indicate a position or an area in a two-dimensional space defined by an X-axis and a Y-axis.

Furthermore, in a case where there are a plurality of virtual space applications, the information unique to the virtual space may include information that enables identification of the virtual space (information that enables uniquely identification of the virtual space in which application). For example, the information unique to the virtual space may include an IP address of the server providing the virtual space. The number of servers providing the virtual space may be one or more. The information unique to the virtual space may include a global IP address or may include a public IP address. For example, the public IP address of the server to which the person who captures images has logged in may be added to the image of the virtual space among a plurality of public IP addresses assigned to the plurality of servers. The information unique to the virtual space may include information of a directory configuration in the server. In the case of a virtual space published on the Internet, the information unique to the virtual space may include a URL.

Note that the time information in the virtual space may indicate a time uniquely determined in the virtual space, or may indicate a time set for an area (world) in the virtual space. Furthermore, the time information in the virtual space may be information indicating a time zone (morning, daytime or night) or information indicating a season. Furthermore, the time information in the virtual space may be information common among a plurality of virtual space applications.

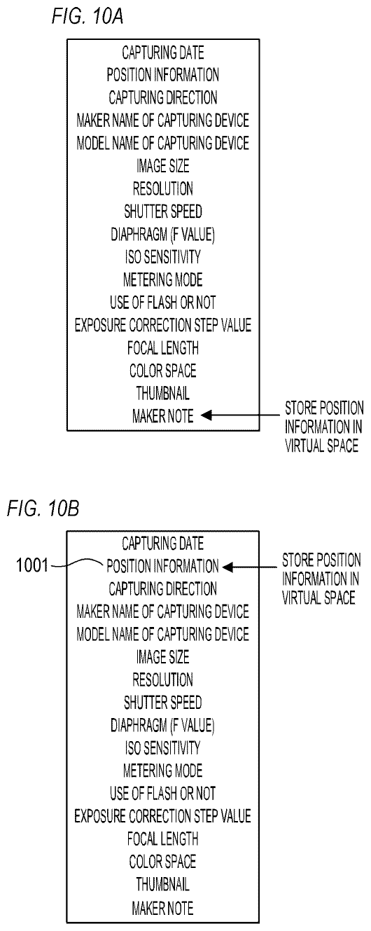

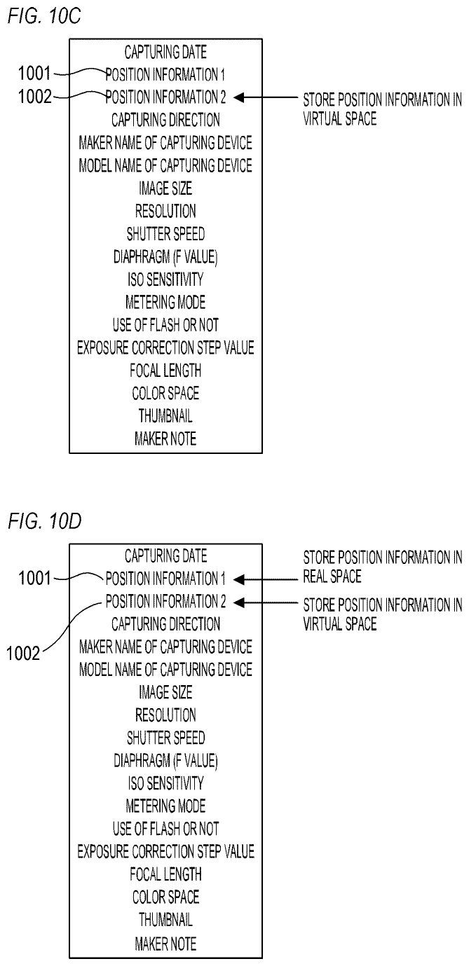

Note that the position information in the virtual space may be stored in Exif format metadata in any manner. For example, as illustrated in FIG. 10A, the position information in the virtual space may be stored in a maker note. As illustrated in FIG. 10B, the metadata in the Exif format may include an area 1001 that stores position information in the real space. In this case, the position information in the virtual space may be stored in the area 1001. As illustrated in FIG. 10C, the metadata in the Exif format may include the area 1001 for storing position information in the real space and an area 1002 for storing position information in the virtual space. In this case, the position information in the virtual space may be stored in the area 1002. As illustrated in FIG. 10D, the position information in the real space may be stored in the area 1001, and the position information in the virtual space may be stored in the area 1002. When two pieces of position information of the position information in the real space and the position information in the virtual space are stored in the metadata, information indicating which of the two pieces of position information is the main information (information used in the playback mode processing (or the processing of the playback device)) may be included in the metadata.

The time information in the virtual space may be stored in the Exif format metadata in any manner. The time information in the virtual space can be stored in the metadata similarly to the position information in the virtual space.

Note that, in a case of using a virtual camera that exists only in the virtual space, the information unique to the virtual space may include the name of the virtual camera to be used. Similarly, when using the virtual camera that exists only in the augmented reality space, the information unique to the augmented reality space may include the name of the virtual camera to be used.

The virtual space and the non-virtual space may be simultaneously captured, and a composite image in which the image of the virtual space and the image of the non-virtual space are arranged may be recorded. For example, a composite image in which the image of the virtual space and the image of the non-virtual space are arranged in a picture-in-picture format may be recorded. The 360° image may be generated as the composite image by combining the image of the virtual space and the image of the non-virtual space each having the angle of view of 180°.

Note that, although the example of adding the metadata to the image has been described, a file of the metadata may be generated and recorded separately from the image file in a format associated with the image. As control for recording information unique to the virtual space, processing of determining a file name of an image of the virtual space according to a predetermined naming rule may be performed. For example, a character string “AppX_VR” indicating the virtual space of the virtual space application AppX, such as a file name “AppX_VR_001.JPEG”, may be included in the file name. Similarly, as control for recording information unique to the augmented reality space, the processing for determining a file name of an image in the augmented reality space according to a predetermined naming rule may be performed. For example, a character string “AppX_AR” indicating the augmented reality space of the virtual space application AppX, such as a file name “AppX_AR_001.JPEG”, may be included in the file name.

Note that, when transmitting an image (image file) to an external device or a server, the electronic device 100 (CPU 101) may not transmit (may delete) a part or all of metadata for privacy protection. For example, when transmitting the image of the virtual space to the external device or the server, the electronic device 100 may not transmit the information unique to the virtual space included in the metadata. The electronic device 100 may transmit (not delete) the metadata when transmitting the image to a specific external device (for example, an external device paired with the electronic device 100), and may not transmit (delete) the metadata when transmitting the image to an external device other than the specific external device. Then, when a specific external device transmits an image to the outside, the metadata may not be transmitted (deleted).

Furthermore, when the display of the virtual camera is shown to another user in the virtual space, the information unique to the real space may be hidden from the partner user. At this time, for example, by selecting a menu to be disclosed to the partner user on the display of the virtual camera, the display of the virtual camera is operated to be shown to another user. Alternatively, whether or not the state is displayed in the field of view of the partner user may be automatically calculated from the position and the line-of-sight direction of the avatar of the partner user, the position of the virtual camera, and the direction of the display surface of the display, and if the state is visible to the partner user, the information unique to the real space may be automatically hidden.

Furthermore, in a case where an image is shared with another user on the virtual space (in a case where an image is transmitted to another user), information unique to the real space may not be transmitted. For example, information unique to the real space may be deleted, and an image in which information of the virtual space is left may be generated and transmitted to another user.

On the contrary, when an image is displayed or shared with another user in the real space, the information unique to the virtual space may not be transmitted (information unique to the virtual space may be deleted). Further, the real user may delete the metadata at optional timing and operation.

As described above, according to the present embodiment, when an image of a virtual space (or an augmented reality space) is recorded, information unique to the virtual space (or the augmented reality space) is recorded. Then, on the basis of the information unique to the virtual space (or the augmented reality space), display that enables identification of the recorded image of the virtual space (or the augmented reality space) is performed. This makes it possible to suitably manage a plurality of images including the image of the virtual space (or the augmented reality space). As a result, the image can be easily searched, edited, and shared.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, it is possible to suitably manage a plurality of images including an image in a virtual space (or an augmented reality space).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An electronic device comprising
one or more processors and/or circuitry configured to:
execute acquisition processing of acquiring information unique to a virtual space; and
execute control processing of performing control to record the information unique to the virtual space when performing control to record an image of the virtual space.

2. The electronic device according to claim 1, wherein
the information unique to the virtual space includes a flag indicating the virtual space.

3. The electronic device according to claim 1, wherein
the information unique to the virtual space includes position information in the virtual space.

4. The electronic device according to claim 1, wherein
the information unique to the virtual space includes time information in the virtual space.

5. The electronic device according to claim 1, wherein
the control of recording the image of the virtual space is control of capturing the virtual space using a virtual camera.

6. The electronic device according to claim 5, wherein
the information unique to the virtual space includes a name of the virtual camera.

7. The electronic device according to claim 1, wherein
the control of recording the information unique to the virtual space includes processing of determining a file name of an image of the virtual space according to a predetermined naming rule.

8. The electronic device according to claim 1, wherein
the control of recording the information unique to the virtual space includes control of recording information in an Exif format.

9. The electronic device according to claim 8, wherein
the information unique to the virtual space includes position information in the virtual space, and
in the control processing, the position information in the virtual space is stored in a maker note.

10. The electronic device according to claim 8, wherein
the information in the Exif format includes an area for storing position information in a real space, and
the information unique to the virtual space includes position information in the virtual space, and
in the control processing, the position information in the virtual space is stored in the area for storing the position information in the real space.

11. The electronic device according to claim 8, wherein
the information in the Exif format includes a first area and a second area for storing position information, and
the information unique to the virtual space includes position information in the virtual space, and
in the control processing, the position information in the virtual space is stored in the second area.

12. The electronic device according to claim 11, wherein
in the control processing, the position information in a real space is stored in the first area.

13. The electronic device according to claim 8, wherein
the information unique to the virtual space includes time information in the virtual space, and
in the control processing, the time information in the virtual space is stored in a maker note.

14. The electronic device according to claim 8, wherein
the information in the Exif format includes an area for storing time information in a real space, and
the information unique to the virtual space includes time information in the virtual space, and
in the control processing, the time information in the virtual space is stored in the area for storing the time information in the real space.

15. The electronic device according to claim 8, wherein
the information in the Exif format includes a third area and a fourth area for storing time information, and
the information unique to the virtual space includes time information in the virtual space, and
in the control processing, the time information in the virtual space is stored in the fourth area.

16. The electronic device according to claim 15, wherein
in the control processing, time information in a real space is stored in the third area.

17. The electronic device according to claim 1, wherein
the one or more processors and/or circuitry further executes setting processing of setting whether or not to record the information unique to the virtual space.

18. The electronic device according to claim 1, wherein
in the control processing, control to transmit the information unique to the virtual space to an external device is not performed when performing control to transmit the image of the virtual space to the external device.

19. The electronic device according to claim 1, wherein
in the control processing, control to transmit the information unique to the virtual space to a specific external device is performed when performing control to transmit the image of the virtual space to the specific external device, and control to transmit the information unique to the virtual space to an external device that is not the specific external device is not performed when performing control to transmit the image of the virtual space to an external device that is not the specific external device.

20. The electronic device according to claim 19, wherein
the specific external device is an external device paired with the electronic device.

21. The electronic device according to claim 1, wherein
the information unique to the virtual space includes information capable of identifying the virtual space.

22. The electronic device according to claim 1, wherein
in the control processing, control to identifiably display a file of the image of the virtual space on a file display screen is performed on a basis of the information unique to the virtual space.

23. The electronic device according to claim 22, wherein
in the control processing, control to identifiably display a file of the image of the virtual space is performed so that an angle of view of the image of the virtual space is capable of being identified.

24. The electronic device according to claim 22, wherein
in the control processing, control to identifiably display the file of the image of the virtual space is performed so that the image of the virtual space is capable of being identified as a two-dimensional image or a three-dimensional image.

25. The electronic device according to claim 1, wherein
in the control processing, control to display information based on at least a part of information unique to the virtual space on an information display screen of the image of the virtual space is performed.

26. The electronic device according to claim 1, wherein
in the control processing, control to display information based on at least a part of information unique to the virtual space on a playback screen of the image of the virtual space is performed.

27. The electronic device according to claim 1, wherein
in the control processing, control to record position information in the virtual space is performed when performing control to record the image of the virtual space, and control to record position information in a real space is performed when performing control to record an image of a space different from the virtual space.

28. The electronic device according to claim 27, wherein
the space different from the virtual space is an augmented reality space.

29. An electronic device comprising
one or more processors and/or circuitry configured to:
execute acquisition processing of acquiring information unique to an augmented reality space; and
execute control processing of performing control to record the information unique to the augmented reality space when performing control to record an image of the augmented reality space.

30. An electronic device comprising
one or more processors and/or circuitry configured to:
execute acquisition processing of acquiring information unique to a virtual space, the information being associated with a file of an image of the virtual space; and
execute control processing of performing control to identifiably display the file of the image of the virtual space on a file display screen on a basis of the information unique to the virtual space.

31. An electronic device comprising
one or more processors and/or circuitry configured to:
execute acquisition processing of acquiring information unique to an augmented reality space, the information being associated with a file of an image of the augmented reality space; and
execute control processing of performing control to identifiably display the file of the image of the augmented reality space on a file display screen on a basis of the information unique to the augmented reality space.

32. A control method of an electronic device, comprising:
acquiring information unique to a virtual space; and
performing control to record the information unique to the virtual space when performing control to record an image of the virtual space.

33. A control method of an electronic device, comprising:
acquiring information unique to an augmented reality space; and
performing control to record the information unique to the augmented reality space when performing control to record an image of the augmented reality space.

34. A control method of an electronic device, comprising:
acquiring information unique to a virtual space, the information being associated with a file of an image of the virtual space; and
performing control to identifiably display the file of the image of the virtual space on a file display screen on a basis of the information unique to the virtual space.

35. A control method of an electronic device, comprising:
acquiring information unique to an augmented reality space, the information being associated with a file of an image of the augmented reality space; and
performing control to identifiably display the file of the image of the augmented reality space on a file display screen on a basis of the information unique to the augmented reality space.

36. A non-transitory computer readable medium that stores a program, wherein the program causes a computer to execute a control method of an electronic device, the control method comprising:
acquiring information unique to a virtual space; and
performing control to record the information unique to the virtual space when performing control to record an image of the virtual space.

37. A non-transitory computer readable medium that stores a program, wherein the program causes a computer to execute a control method of an electronic device, the control method comprising:
acquiring information unique to an augmented reality space; and
performing control to record the information unique to the augmented reality space when performing control to record an image of the augmented reality space.

38. A non-transitory computer readable medium that stores a program, wherein the program causes a computer to execute a control method of an electronic device, the control method comprising:
acquiring information unique to a virtual space, the information being associated with a file of an image of the virtual space; and
performing control to identifiably display the file of the image of the virtual space on a file display screen on a basis of the information unique to the virtual space.

39. A non-transitory computer readable medium that stores a program, wherein the program causes a computer to execute a control method of an electronic device, the control method comprising:
acquiring information unique to an augmented reality space, the information being associated with a file of an image of the augmented reality space; and
performing control to identifiably display the file of the image of the augmented reality space on a file display screen on a basis of the information unique to the augmented reality space.
